(19) United States
(12) Patent Application Publication
(10) Pub. No.: US 2025/0346540 A1
(43) Pub. Date: Nov. 13, 2025

(54) SOIL AMENDMENT AND METHOD OF USING THE SAME

(71) Applicant: WestMET Group Holdings, LLC, Lone Tree, CO (US)

(72) Inventors: Clayton R. Williams, Hanna (CA); Ridley Huculak, Edmonton (CA)

(21) Appl. No.: 19/204,965

(22) Filed: May 12, 2025

Related U.S. Application Data
(60) Provisional application No. 63/645,325, filed on May 10, 2024.

(51) Int. Cl. C05G 3/80; C05B 17/00; C05D 9/00; C05F 11/02; C05F 11/08; C09K 17/10

(52) U.S. Cl. CPC C05G 3/80; C05B 17/00; C05D 9/00; C05F 11/02; C05F 11/08; C09K 17/10

(57) ABSTRACT

A method for lowering a sodium absorption ration (SAR) in soil, the method comprising: measuring an initial sodium absorption ration (SAR) in a soil sample; applying a soil amendment comprising humalite, gypsum, and agricultural lime (Ag lime) to the soil; and subsequently measuring the SAR of a soil sample containing the applied soil amendment.

### CROSS-REFERENCE TO RELATED APPLICATIONS

This application claims the priority benefit of U.S. Provisional Patent Application No. 63/645,325 filed May 10, 2024, which is hereby incorporated herein by reference in its entirety.

### FIELD OF INVENTION

The present disclosure generally relates to a soil amendment that can be added to overburden soil to adjust levels of SAR (Sodium absorption ration) and pH in the soil.

### BACKGROUND

In mining processes, the soil within the mining site undergoes significant alterations and disturbances due to the extraction of minerals or ores from beneath the earth's surface. Mining operations often begin with the excavation of the soil to access the mineral deposits underneath. This involves removing the topsoil, subsoil, and overlying layers of earth to reach the desired ore bodies. The excavated soil, also known as overburden, can usually be stockpiled nearby for later reclamation. However, during this process, the soil may be left exposed to the elements, leading to erosion and degradation. During this process, overburden typically can be leveled with a dozer, then a regulated thickness of subsoil can be placed followed by a placement of topsoil. If the levelled overburden meets the criteria for sodium absorption ration (SAR) and pH, then subsoil placement may often not be required, and the levelled overburden can be claimed as subsoil. If overburden does not meet the required criteria, it may typically be due to a high level of SAR, a high pH level, or a combination of the two.

Mining activities can disrupt the natural structure and composition of the soil. Heavy machinery used in mining operations compacts the soil, reducing its porosity, overall soil structure, while also disrupting its ability to hold water and nutrients.

After mining activities cease in a particular area, efforts are often made to rehabilitate and restore the disturbed soil. This process, known as reclamation, involves re-grading the land, replacing topsoil, and re-vegetating the area to encourage the growth of native plant species. Reclamation aims to stabilize the soil, prevent erosion, and mitigate environmental impacts caused by mining activities.

Overall, the soil in mining areas undergoes significant changes, including excavation, compaction, contamination, and eventual reclamation efforts. These alterations can have long-lasting effects on soil quality, ecosystem health, and surrounding communities. Proper planning and management practices are essential to minimize the negative impacts of mining on soil and the environment.

### BRIEF DESCRIPTION OF THE DRAWINGS

While the specification concludes with claims which particularly point out and distinctly claim this technology, it is believed that this technology will be better understood from the following description of certain examples taken in conjunction with the accompanying drawings, in which like reference numeral identify the same elements and in which:

FIG. 1 is a drawing illustrating an example blending process for forming a soil amendment of the present disclosure.

FIG. 2 is a drawing illustrating an example application process for applying a soil amendment of the present disclosure to a subsoil area.

FIG. 3 is a graph showing the effects on SAR of a soil sample that a soil amendment containing humalite may have; and

FIG. 4 is a graph showing the effects on pH of a soil amendment containing AG lime may have.

The drawings are not intended to be limiting in any way, and it is contemplated that various embodiments of the technology may be carried out in a variety of other ways, including those not necessarily depicted in the drawings. The accompanying drawings incorporated in and forming a part of the specification illustrate several aspects of the present technology, and together with the description explain the principles of the technology; it being understood, however, that this technology is not limited to the precise arrangements shown.

### DETAILED DESCRIPTION

The following description of certain examples of the technology should not be used to limit its scope. Other examples, features, aspects, embodiments, and advantages of the technology will become apparent to those skilled in the art from the following description, which is by way of illustration, one of the best modes contemplated for carrying out the technology. As will be realized, the technology described herein is capable of other different and obvious aspects, all without departing from the technology. Accordingly, the drawings and descriptions should be regarded as illustrative in nature and not restrictive.

It is further understood that any one or more of the teachings, expressions, embodiments, examples, etc. described herein may be combined with any one or more of the other teachings, expressions, embodiments, examples, etc. that are described herein. The following-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

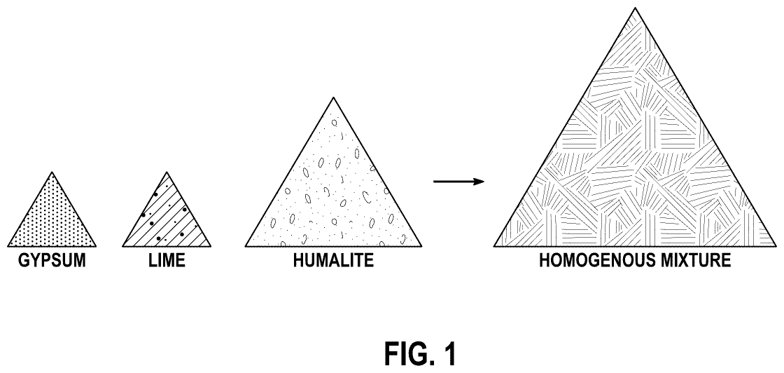

In one or more versions, the present disclosure teaches a soil amendment including a combination of a humic material, such as humalite, gypsum, and agricultural lime (Ag lime) blended together into a stockpile and utilized to interact within a stockpile for a set period of time prior to the blended stockpile being used in a soil reclamation process to convert overburden material into usable subsoil. FIG. 1 shows an example blending process for forming a homogenous mixture of one version of a soil amendment including a combination of humalite, gypsum, and Ag lime. In one or more versions, soil amendments of the present disclosure include from 10% to 90% of humalite, from 5% to 80% of gypsum, and from 5% to 80% of Ag lime.

In the reclamation industry, the process of reclaiming previously mined areas must go through the process of levelling, subsoiling, topsoiling, then revegetation. In the process of levelling, the previously mined area must be regraded to meet pre-mined slopes. This subspoil material, also known as an overburden material, can be a mixture of all the material from above the targeted mine seam to below the subsoil. The overburden material tends to be higher than the subsoil in the area for SAR (sodium adsorption ratio) and can have varying pH levels.

The subsoiling process typically can be salvaged prior to mining but can be a shortage at time of replacement. The subsoiling process requires replacing the subsoil to a thickness that meets the regulation requirements. The overburden material can be classified as subsoil if it meets requirements in certain categories including SAR and pH. The specific SAR and PH levels that are considered “passing” changes from one mining location to the next. But in one example, at the Sheerness Coal Mine in Alberta Canada, the passing value of SAR is 12.5, but can vary from location to location.

After either subsoiling or reclassifying subspoil as subsoil, the area can then be topsoiled and then revegetated. The goal may be to make sure the subsoil and topsoil meet the requirements to get full vegetation. In one or more versions, the optimal pH of quality topsoil can be between 6.2-6.8 and subsequently should be the target of the subsoil as well. In one or more versions, the optimal SAR level can be to get the SAR level as low as possible without affecting the overall viability of the soil.

Humalite is a type of humic substance that is derived from ancient organic matter, such as decomposed plants and animals, that has undergone a process of humification over millions of years. Humification is the process of forming humic substances, which are organic matter that has reached maturity. Humification is the opposite of mineralization, which releases nutrients from dead organic matter into inorganic forms. Humic Acid can also be found in deposits known as Leonardite, which are typically mined for their humic acid content. Humalite is the richest in humic and fulvic acids of all humic substances, which are organic compounds that play important roles in soil fertility and plant growth. Humalite is the highest quality humic substance in the world found only in Alberta Canada. Leonardite is another form of humic substance inferior to humalite in humic acid content. Humalite is also lower in heavy metals due to being formed in fresh water rather than salt water.

Gypsum is a soft sulfate mineral composed of calcium sulfate dihydrate, with the chemical formula CaSO₄·2H₂O. Gypsum is widely distributed and occurs in various forms, including as a natural mineral, as well as in synthetic forms. In one or more versions, gypsum forms as a result of the evaporation of saline water bodies, such as seas or lakes, where the concentration of dissolved calcium and sulfate ions becomes high enough for gypsum to precipitate out of solution. It can also form through the evaporation of groundwater in arid environments. Gypsum typically appears transparent to opaque crystals or massive granular masses. Gypsum has a hardness of 2 on the Mohs scale, which means it can be considered relatively soft and can be easily scratched with a fingernail. Gypsum crystals can exhibit various colors, including white, colorless, gray, brown, and pink.

Agricultural lime, also known as Ag lime, is composed primarily of calcium carbonate (CaCO₃) or calcium magnesium carbonate (CaMg(CO₃)₂) derived from crushed limestone or dolomite rock. Agricultural lime works by neutralizing soil acidity through a process known as liming. Acidic soils have a low pH, which can inhibit the availability of essential nutrients to plants and may lead to poor crop yields. Lime raises the pH of acidic soils, making them more neutral or alkaline, which improves nutrient availability and enhances plant growth.

In one or more versions, soil amendments of the present disclosure can convert failed subspoil to passing subsoil. In one or more versions, the inclusion of a humic material, such as humalite, in the soil amendment can reduce the SAR of a failed subspoil, however, due to humalite having a base pH of at 3.5-4.0, an excessive use of humalite can reduce the pH of the final subsoil material too low and cause the subsoil to fail pH requirements. In order to combat this, soil amendments of one or more versions also include both Ag Lime and gypsum which may act as a buffer of the pH of the final product to a point that the subsoil can have a final incorporated pH of no less than 6.0.

In one or more versions, the process of mixing the humic material, such as humalite, Ag lime, and gypsum together allows for a further enhancement of the effects of humalite on its own. In one or more versions, a final mixture of soil amendments of the present disclosure can have varying amounts of the gypsum, Ag lime, and humalite to target specific pH requirements depending on the targeted final pH of the product.

The area in which soil amendments of the present disclosure are added can be determined based on taking a measurement of the SAR and/or pH in a particular area, and seeing by how much the soil fails the SAR and/or pH requirements for the particular region that the soil may be located in. These areas typically fail the SAR requirements by having too high an SAR level while these areas can fail pH requirements by having either too high of a pH or too low of a pH, as most pH requirements require a neutral pH reading.

In one or more versions, SAR may be measured by taking samples to the desired subsoil depth and having them lab tested for SAR.

In one or more version, pH may be measured by taking samples to the desired subsoil depth and having the samples lab tested for pH.

In one or more versions, once an area has been determined as needing the soil amendments of the present disclosure, one of the first steps may be too make sure that the application area is smooth enough for the application of the soil amendment. In one or more versions, the incorporation process can entail spreading the product at a rate of 1% by mass of the subsoil depth incorporated to for every 0.5 reduction required in SAR of the subsoil. In one or more versions, the rate of spread can be from 0.5% to 5%, from 0.5% to 3.5%, from 0.5% to 2%, or from 0.5% to 1.5%. In one or more versions, the incorporation process can entail spreading the product at a rate of 25 metric tons per 0.5 reduction in SAR needed. In one or more versions, the density of the in-situ material needs determined post swelled from the process of incorporation. In one or more versions, incorporation may only be required to a portion of the final depth of the subsoil requirement due to mobility of the soil amendment in the soil. This depth can be determined by incorporation tools such as, but not limited to, tillage tools including a heavy disc, cultivators, or moldboard plows. In one or more versions, an incorporation depth of 75% of the total depth may be needed. In yet other versions, the incorporation depth can be from 50% to 90% of the total depth, from 60% to 85%, or from 70% to 80%. In one or more versions, the incorporation of soil amendments of the present disclosure could take multiple passes utilizing the above disclosed rates or spread and incorporation depth until the entire incorporation volume may be incorporated. Once incorporated into the in-situ material, the soil amendments of the present disclosure require time to settle and moisture to make the reaction happen. This time may vary depending on moisture and temperature levels. In one or more versions, the soil amendments of the present disclosure may have a moisture content of about 30% and the temperature should be kept about freezing.

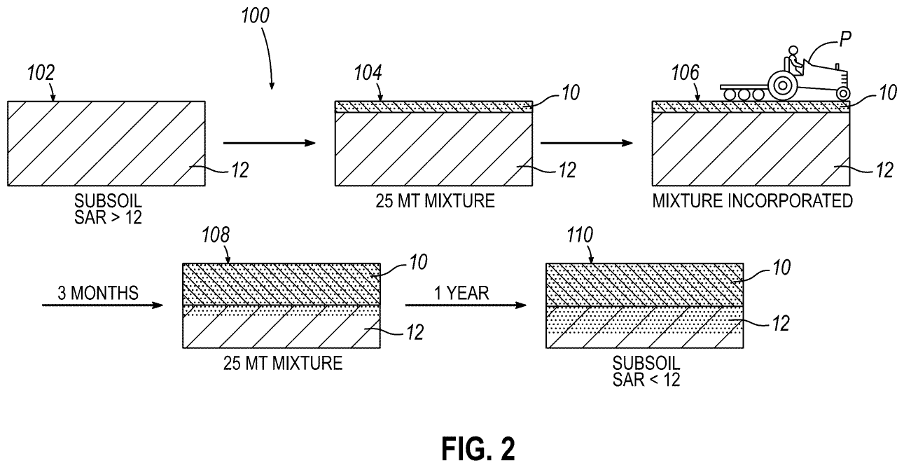

FIG. 2 shows an example incorporation process 100 for utilizing soil amendments of the present disclosure. In a step 102, a subsoil area 12 may be determined as needing the soil amendments of the present disclosure based on taking an SAR measurement of the subsoil area reading the SAR level as being higher than 12. SAR is a value representing the relative amount of sodium ions to the combined amount of calcium and magnesium ions in water using the following formula: SAR=[Na]/(([Ca]+[Mg])/2)½, where all concentrations are expressed as milliequivalents of charge per liter In a step 104, a soil amendment 10 of the present disclosure can be spread on the surface at a rate of 25 mt. In a step 106, the spread soil amendment can be incorporated into the subsoil through the use of moldboard plows P. Step 108 shows how the soil amendment 10 has settled into the subsoil 12 three months after application of soil amendment 10. In one or more versions, at step 108, the SAR of the subsoil area 12 has a SAR level of less than 12. Step 110 shows how the soil amendment 10 has settled even further into the subsoil 12 at one year after application of soil amendment 10 as compared to step 108. In one or more versions, at step 110, the SAR of the subsoil area 12 has a SAR level of less than 12.

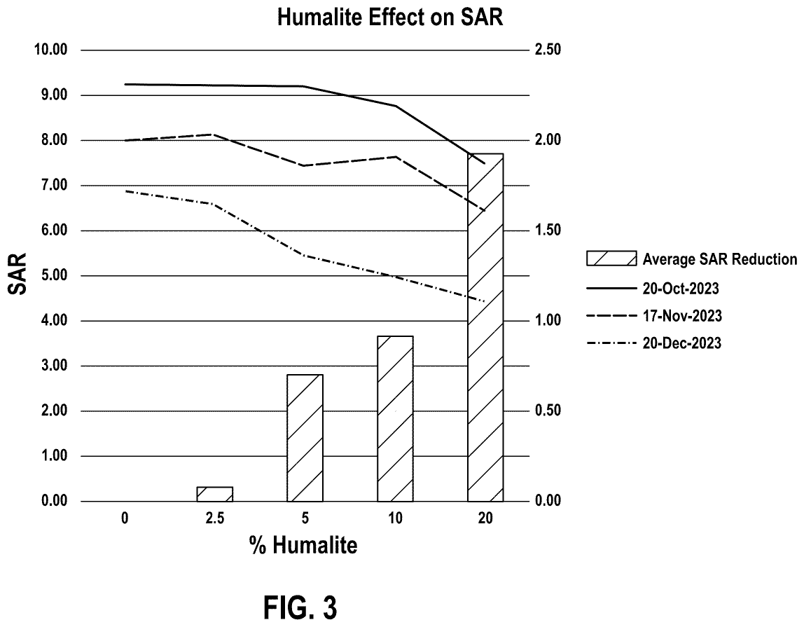

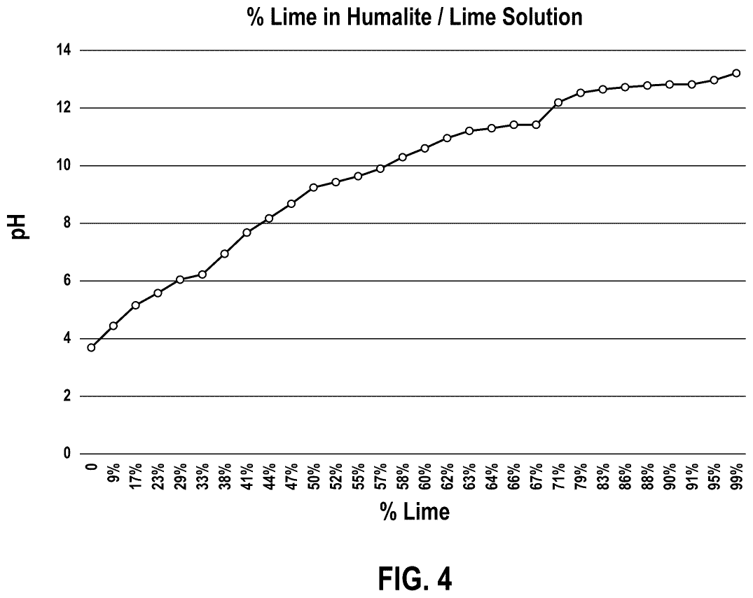

FIG. 3 is a chart showing the effects on SAR that humalite can have. As can be seen, the higher percentage of humalite in the soil amendment, the larger the decrease of SAR in the soil sample. FIG. 4 is a chart showing the effects on pH that AG lime can have on a humalite mixture. As can be seen, the higher percentage of AG lime in the soil amendment, the larger the increase of pH in the humalite mixture.

In one or more versions, addition of the soil amendments of the present disclosure can include an increased water holding capacity, improved soil structure, added organic matter, and an improved microbial activity in the final soil product. Increased water holding capacity can occur due to the inclusion of a humic material, such as humalite, as increased water holding capacity is a natural property of humalite. Improved soil structure can occur as the humalite in the soil amendments may break down particles that are hard bound together, such as clay. Organic matter can be added to the final soil product through the inclusion of humalite as increased water holding capacity is a natural property of humalite. The final soil product can see an increase in microbial activity through the inclusion of humalite as increased water holding capacity is a natural property of humalite.

In one or more versions, soil amendments of the present disclosure may also be utilized to increase agronomic performance of topsoil. In one or more versions, the concentration of the humic material, such as humalite, Ag Lime, gypsum, or combinations of all three can be changed to suit the agronomic needs of topsoil. In one or more versions, the final mixture of the soil amendment of the present disclosure may be determined on whether the pH of the topsoil needs to be increased or decreased. In one version, if the pH of the topsoil needs to be lowered, then the final mixture may be predominantly humalite with additions of the gypsum and Ag lime. In one version, if the pH of the topsoil needs to be increased, then the final mixture may be predominantly gypsum and Ag Lime with an addition of humalite. In one or more versions, soil amendments of the present disclosure may be used in relatively large application rates to improve highly salinic, extreme pH levels, low calcium level, and solonetzic topsoils. The addition of soil amendments of the present disclosure to topsoils having these features may break up hard clay soils and make them much more agronomic friendly topsoils for plant growth.

In one or more versions, once the ingredients, including the humic material, such as humalite, Ag Lime, and gypsum have been blended together, the blended product may be granulated. In one or more versions, the granulation process includes compression into pellets or by pan granulation.

In an additional version of the present disclosure, raw mined element products can be combined with biologicals to increase plant growth in areas with topsoil needing such assistance. In one or more versions, the plant growth assistance amendment may include a combination of a humic material, such as humalite, compost, Ag lime, gypsum, elemental sulfur, rock phosphorus, microbes, and biologicals. In one or more versions, soil amendments of the present disclosure include from 10% to 90% of humalite, from 5% to 50% of compost, from 5% to 80% of gypsum, from 5% to 80% of Ag lime, from 5% to 50% of elemental sulfur, from 5% to 50% of rock phosphorus, from 5% to 50% microbes, and from 5% to 50% biologicals. In one or more versions, compost includes but is not limited to animal manure and biosolids. In one or more versions, microbes include but are not limited to bacteria and mycorrhizae fungi. In one or more versions, biologicals include but are not limited to bacteria, mycorrhizae fungi, and also products generally derived from plants, animals, and human cells and tissues.

In one or more versions, the compost and a humic material, such as humalite may first be mixed together to form a first homogenized mixture. In one or more versions, the compost and humalite are blended at a desired rate and placed into a stockpile with sufficient moisture and of a shape and size that may allow for air to reach the center of the stockpile. To make sure that air reaches the center of the stockpile, the stockpile should be thoroughly mixed ever 2-6 weeks. A combination of Ag lime, gypsum, element sulfur, rock phosphorus, microbes, and biologicals may then be added to the first homogenized mixture of compost and humalite to form a second homogenized mixture. In one or more versions, the second homogenized mixture may then be pelletized to increase its handleability. In one or more versions, the plant growth assistance amendment has an incorporation process including but not limited to discing, harrowing, and floating. In one or more versions, the plant growth assistance amendment can include applications such as, but not limited to, an organic fertilizer, soil building amendment, horticultural applications, law and garden applications, and turf applications. In one or more versions, humalite acts as a bio-stimulant within the plant growth assistance amendment, the Ag lime, gypsum, element sulfur, and rock phosphorus adds micro and macro nutrients to the plant growth assistance amendment, and the microbes and biologicals build up the topsoil such that the plant growth assistance amendment may act as a regenerative amendment.

The use of the plant growth assistance amendment may allow for the natural slow release of minerals that can be used by plants without loss to the environment. The organic matter within the soil amendment may allow for carbon to be naturally built within the soil, while at the same time adding vital nutrients required for soil performance. With the addition of the humic material, all of the issues previously encountered when trying to use each of the additives individually can be mitigated. The humic material, when composted with the active manure/compost, may chemically break down individual elements to become plant available from their stable raw state.

In one or more versions, the plant growth assistance amendment may include a blend of a humic material, such as humalite, compost, gypsum, lime, and rock phosphorus. The benefits that may be seen from using this plant growth assistance amendment may include high biological activity, an active biostimulant, chemically available calcium, the breakdown of plant available forms of phosphorus, high organic matter content, buffering of soil pH, and/or smell reduction. Humic Acid is partially extracted when composting due to the addition of the lime giving a pH change within the stockpile. Humic materials increase root and shoot growth as well as overall plant health and performance. This allows for the plant growth assistance amendment to be an effective soil starter.

The calcium from the gypsum will be chemically available from the bioactivity of the compost and humic material. Composting raw rock phosphorous with the humic material and compost may allow for breakdown into plant available forms of phosphorus. The ratios of raw rock phosphate within the plant growth assistance amendment can be altered to add or reduced to effect the amount of available phosphorous within the plant growth assistance amendment. The amount of time the blended stockpile is allowed to compost will affect the amount of slow and quick release phosphorus available in the plant growth assistance amendment. The plant growth assistance amendment will be of a very high organic matter content that has a range of young soluble organic matter from the compost portion of the plant growth assistance amendment, as well as mature soil building humin (natured organic matter) from the humic material (Humalite). The final plant growth assistance amendment may also be composed of the entire spectrum of organic matter: live organisms (compost), decomposed dead matter (compost), Humin (humic material), Humic Acid (humic material) and Fulvic Acid (humic material). The biostimulant provided by the humic material (humalite) allows for the soil to be pH buffered to the desired neutral state of approximately 7. By manipulating the feed ingredients to be higher in Humic the plant growth assistance amendment can have a lower pH reducing the pH in the soil as desired in some instances. In cases where the pH is required to be increased, a higher ratio of lime can be added to the recipe to allow for the plant growth assistance amendment to have a naturally higher pH. The effects of the lime may also be improved with the humic material to make it more available and quicker reacting. Another action that is provided by the plant growth assistance amendment may be a significant reduction in smell of the final blend from the original ingredients.

In one or more versions, humic materials, such as humalite, may be blended with any manure collected via lagoon, pit, stockpile, or other. By blending the raw humic material into the manure and fully mixed/incorporated, the final blend may be a product suitable for soil building purposes. The process of adding the humic material to the manure may also reduce the smell of the overall mixture. In one example of the use of humic materials in this manner, three containers were prepared with one containing 1.8 kg of tilled Humalite powder into manure, one with 1.9 kg of carbon granules placed on the top of manure, and one with just manure. The containers were scaled and over a series of test times, from 1-hour to 96-hours, odor samples were extracted and evaluated by an eight-member odor panel who are trained and experienced in odor assessments for odor detection and recognition threshold values following ASTM E679-19 and EN13725: 2022 test methodologies, odor intensity following ASTM E544-24 test methodology, as well as character profiling and hedonic tone measurements.

Results from the above example found an overall reduction in the concentration of the odor emissions collected from insides the test containers across all time test periods for the container containing Humalite powder and manure. While this reduction was not statistically significant at the 1-hour, 4-hour, 24-hour, and 48-hour test times, at the 96-hour test time using the dataset and performing an analysis of variance along with a post-hoc Fisher's Least Significant Difference (LSD) test (α=0.05), the Humalite was shown to reduce the overall odor emissions collected from inside the test container by about 58%. The results from the odor testing showed that when Humalite was added and tilled into the manure at a 20% volume dosing ratio, there was a reduction in the overall concentration of the odor emissions collected from inside in the test containers across all time test periods to a varying degree.

In an additional version of the present disclosure, humalite and compost can be combined together to form an improved water holding capacity amendment. In one version, the improved water holding capacity amendment includes 25% compost and 75% humalite. In one or more versions, the improved water holding capacity amendment includes from 10% to 40% compost, from 15% to 35% compost, or from 20% to 30% compost. In one or more versions, the improved water holding capacity amendment includes from 90% to 60% humalite, from 85% to 65% humalite, or from 80% to 70% humalite. In one or more versions, the improved water holding capacity amendment can be spread onto topsoil and then incorporated into the topsoil. Prior to application of the water holder capacity amendment, in one or more versions, the humalite and compost can be mixed together to form a homogenized mixture and then the homogenized mixture sits for four weeks prior to application to the topsoil. In one or more versions, the homogenized mixture sits for from one weeks to ten weeks prior to application, from two weeks to eight weeks, or from three weeks to 6 weeks.

In one or more versions, humic materials, such as humalite, may be combined with compost and a suitable subsoil to build an anothroposol topsoil sufficient for reclamation purposes. These anothroposol topsoils may be superior to the organic topsoil in many cases by increasing the chemical and organic content of the soil left behind as compared to the native organic topsoil of the local area. The process to build topsoil may start with determining if the existing subsoil is of sufficient quality to build into topsoil. Testing is required to make sure that it meets the criteria of a low enough SAR, pH within a certain range, and the saturation levels. In order to build subsoil material into a suitable topsoil, the addition of both compost and humic material needs to be added in a measured and controlled matter to match the topsoils in the surrounding areas. The addition rate of the blended humalite and compost may be determined by the volume and amount of organic matter required to increase by: Dry metric ton Product/area=Topsoil thickness×area×organic matter increase. An example of this determination can be: 20 metric tons of blended product per hectare=12 cm thickness×1 hectare×1% organic matter increase.

In one or more versions, the process of getting to the usable topsoil may first need to determine the application rate of blended products by determining the original subsoil quality as well as the desired final organic matter requirements. Next, the compost manure may be spread at required rates over the fabrication area of prepped subsoil. Next, the humic material, such as humalite, may be spread at required rates over the prepped subsoil. Next, the applied compost and humic material may need to be incorporated to their desired depths within the subsoil, typically a regulated depth to match the makeup of the topsoil in the areas surrounding the prepped subsoil. Next, the incorporated area may be seeded with a reclamation seed mixture. In one or more versions, reclamation seed mixture may include grass, cereal, or combinations thereof. Next, the final mixture may need to be monitored to make sure that it matches the targeted organic material requirements. Next, dependent on the monitoring results, more of the compost/humalite mixture may be added to increase the overall organic material.

In one or more versions, humic materials, such as humalite, may be combined with compost and added to insufficient subsoil as an alternative to topsoil placement to amend the insufficient subsoil to meet all relevant quality criteria. Such a combination of a humic material, such as humalite, with compost may be used as a reclamation growing medium (RGM) for the purposes of reclamation of sites of forming mining projects. In one or more versions of using a combination of a humic material, such as humalite, with compost may be used as a RGM may supply a minimum carbon to nitrogen ratio (C:N) of 15, a maximum organic matter (OM) concentration of 15%, a total nitrogen (TN) concentration between 0.2% and 0.6%, and a nitrate concentration between 10 and 80 mg/kg. In one or more versions, the RGM of the present disclosure may be applied to designated areas with a tractor-powered manure spreaders. After application, the RGM of the present disclosure may be mixed in-situ with any suitable subsoil in the designated area using an agricultural disc implement to incorporate the RGM to a depth of about between about 0.10 meters and 0.15 meters below ground surface. In one version, the RGM may be incorporated to a depth of 0.12 meters below ground surface. In one or more versions, once the RGM has been incorporated, the designated areas may be seeded.

Based on relevant testing, humic materials, such as humalite, combined with compost and directly applied to subsoil to create an RGM in situ were successful in achieving the desired reclamation goals, verifying the use of RGM to fabricate a soil layer that mimics topsoil in terms of functionality and productivity. The fabricated RGM of the present disclosure met the optimum nutrient target ranges while establishing vegetation and meeting the trace element quality criteria for agricultural areas. Fabricated RGM's of the present disclosure can be used to overcome the topsoil shortfall at sites of previous mining activity and may complete the reclamation without having to import unsustainable sources of topsoil.

### Exemplary Combinations

The following examples relate to various non-exhaustive ways in which the teachings herein may be combined or applied. It should be understood that the following examples are not intended to restrict the coverage of any claims that may be presented at any time in this application or in subsequent filings of this application. No disclaimer is intended. The following examples are being provided for nothing more than merely illustrative purposes. It is contemplated that the various teachings herein may be arranged and applied in numerous other ways. It is also contemplated that some variations may omit certain features referred to in the examples below. Therefore, none of the aspects or features referred to below should be deemed critical unless otherwise explicitly indicated as such at a later date by the inventors or by a successor in interest to the inventors. If any claims are presented in this application or in subsequent filings related to this application that include additional features beyond those referred to below, those additional features shall not be presumed to have been added for any reason relating to patentability.

### Example 1

A method for lowering a sodium absorption ration (SAR) in soil, the method comprising: measuring an initial sodium absorption ration (SAR) in a soil sample; applying a soil amendment comprising humalite, gypsum, and agricultural lime (Ag lime) to the soil; and subsequently measuring the SAR of a soil sample containing the applied soil amendment.

### Example 2

The method of Example 1, further comprising the step of determining the amount of humalite contained within the soil amendment based on the initial SAR.

### Example 3

The method of Example 1 or 2, further comprising the step of determining the amount of gypsum contained within the soil amendment based on the initial SAR.

Example 4

The method of any one of Examples 1 through 3, further comprising the step of determining the amount of Ag lime contained within the soil amendment based on the initial SAR.

Example 5

The method of any one of Examples 1 through 4, wherein the initial SAR is measured by taking the soil sample at a desired subsoil depth and having the soil sample lab tested for the initial SAR.

Example 6

The method of any one of Examples 1 through 5, further comprising the step of measuring an initial pH level of the soil sample prior to application of the soil amendment.

Example 7

The method of any one of Examples 1 through 6, further comprising the step of determining the amount of humalite contained within the soil amendment based on the initial pH level.

Example 8

The method of Example 6 or 7, further comprising the step of determining the amount of gypsum contained within the soil amendment based on the initial pH level.

Example 9

The method of any one of Examples 6 through 8, further comprising the step of determining the amount of Ag lime contained within the soil amendment based on the initial pH level.

Example 10

The method of any one of Examples 6 through 9, further comprising the step of subsequently measuring a pH level of the soil sample after application of the soil amendment.

Example 11

The method of any one of Examples 1 through 10, further comprising smoothing of an application area of the soil prior to application of the soil amendment.

Example 12

The method of any one of Examples 1 through 11, further comprising a step of incorporating the soil amendment into the soil after application of the soil amendment.

Example 13

The method of Example 12, wherein the step of applying the soil amendment includes spreading the soil amendment at a rate of 1% by mass of a soil depth of incorporation of the soil amendment for every 0.5 reduction required in SAR of the soil.

Example 14

A soil amendment for lowering a sodium absorption ration (SAR) in soil comprising: humalite, gypsum, and agricultural lime (Ag lime).

Example 15

The soil amendment of Example 14, comprising 10% to 90% of humalite, from 5% to 80% of gypsum, and from 5% to 80% of Ag lime.

Example 16

The soil amendment of Example 14 or 15, further comprising element sulfur, rock phosphorus, microbes, and biologicals.

### Miscellaneous

It should be understood that any of the versions of the disclosure described herein may include various other features in addition to or in lieu of those described above. By way of example only, any versions described herein may also include one or more of the various features disclosed in any of the various references that are incorporated by reference herein. It should also be understood that the teachings herein may be readily applied to any of the versions described in any of the other references cited herein, such that the teachings herein may be readily combined with the teachings of any of the references cited herein in numerous ways. Other types of versions into which the teachings herein may be incorporated will be apparent to those of ordinary skill in the art.

It should also be understood that any ranges of values referred to herein should be read to include the upper and lower boundaries of such ranges. For instance, a range expressed as ranging “between approximately 1.0 inches and approximately 1.5 inches” should be read to include approximately 1.0 inches and approximately 1.5 inches, in addition to including the values between those upper and lower boundaries.

It should be appreciated that any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

Having shown and described various versions of the present invention, further adaptations of the methods and systems described herein may be accomplished by appropriate modifications by one of ordinary skill in the art without departing from the scope of the present invention. Several such potential modifications have been mentioned, and others will be apparent to those skilled in the art. For instance, the examples, versions, geometrics, materials, dimensions, ratios, steps, and the like discussed above are illustrative and are not required. Accordingly, the scope of the present invention should be considered in terms of the following claims and is understood not to be limited to the details of structure and operation shown and described in the specification and drawings.

What is claimed is:

1. A method for lowering a sodium absorption ration (SAR) in soil, the method comprising: measuring an initial sodium absorption ration (SAR) in a soil sample; applying a soil amendment comprising humalite, gypsum, and agricultural lime (Ag lime) to the soil; and subsequently measuring the SAR of a soil sample containing the applied soil amendment.

2. The method of claim 1, further comprising the step of determining the amount of humalite contained within the soil amendment based on the initial SAR.

3. The method of claim 1, further comprising the step of determining the amount of gypsum contained within the soil amendment based on the initial SAR.

4. The method of claim 1, further comprising the step of determining the amount of Ag lime contained within the soil amendment based on the initial SAR.

5. The method of claim 1, wherein the initial SAR is measured by taking the soil sample at a desired subsoil depth and having the soil sample lab tested for the initial SAR.

6. The method of claim 1, further comprising the step of measuring an initial pH level of the soil sample prior to application of the soil amendment.

7. The method of claim 6, further comprising the step of determining the amount of humalite contained within the soil amendment based on the initial pH level.

8. The method of claim 6, further comprising the step of determining the amount of gypsum contained within the soil amendment based on the initial pH level.

9. The method of claim 6, further comprising the step of determining the amount of Ag lime contained within the soil amendment based on the initial pH level.

10. The method of claim 6, further comprising the step of subsequently measuring a pH level of the soil sample after application of the soil amendment.

11. The method of claim 1, further comprising smoothing of an application area of the soil prior to application of the soil amendment.

12. The method of claim 1, further comprising a step of incorporating the soil amendment into the soil after application of the soil amendment.

13. The method of claim 12, wherein the step of applying the soil amendment includes spreading the soil amendment at a rate of 1% by mass of a soil depth of incorporation of the soil amendment for every 0.5 reduction required in SAR of the soil.

14. A soil amendment for lowering a sodium absorption ration (SAR) in soil comprising: humalite, gypsum, and agricultural lime (Ag lime).

15. The soil amendment of claim 14, comprising 10% to 90% of humalite, from 5% to 80% of gypsum, and from 5% to 80% of Ag lime.

16. The soil amendment of claim 14, further comprising element sulfur, rock phosphorus, microbes, and biologicals.
